(19) United States
(12) Patent Application Publication
(10) Pub. No.: US 2008/0041104 A1
(43) Pub. Date: Feb. 21, 2008

(54) Foamed Glass Cooling Run

(76) Inventor: Walter Frank, Weiden (DE)

Correspondence Address: LOWRIE, LANDO & ANASTASI, LLP, ONE MAIN STREET, SUITE 1100, CAMBRIDGE, MA, 02142, US

(21) Appl. No.: 11/660,536

(22) PCT Filed: Aug. 18, 2005
(86) PCT No.: PCT/EP05/54091

§ 371 Date: Sep. 20, 2007

(30) Foreign Application Priority Data
Aug. 19, 2004 (DE) 10 2004 040 307.4

(51) Int. Cl. C03B 19/08; C03B 5/00

(52) U.S. Cl. 65/22; 65/348

(57) ABSTRACT

The invention relates to a device and a method for the continuous production of one-piece foamed glass sheets, whereby the foamed glass is foamed form glass particles and a blowing agent with a thermal treatment to give an endless foamed glass web (16) and directly after foaming, the foamed glass web (16) is continuously cooled to room temperature at such a rate that the foamed glass has a stress-free structure made up of glass and a number of pores.

### TECHNICAL BACKGROUND

The present invention refers to a device and a method for producing foam glass plates according to the generic term of claims 11 and 1, respectively.

Foam glass is known for a long time. In the EP 121 14 B1 a method for producing foam glass granulate is described. According to this method a mixture of a finely ground glass powder and a paste-like blowing agent consisting of water, sodium silicate, glycerine and sodium bentonite is produced which is dried and, after adding a further amount of glass powder, is swelled in an apron conveyer furnace. The mixture of blowing agent and glass powder is carried through the furnace by an endless conveyer so that by application of heat and by means of the blowing agent a strand of foam glass is formed, the glass particles being sintered together by formation of a plurality of pores. This strand of foam glass dissociates at the furnace exit due to internal stresses so as to form a plurality of small granules, the so-called gravel.

This gravel can be connected by means of a fixing agent to a structural part, as for example described in EP 09 45 412 B1.

Further, a method for producing one-piece foam glass plates is known, according to which the glass powder, together with the blowing agent, is introduced in a corresponding mould, whereupon the moulds together with the blowing agent and the glass powder undergo a heat treatment afterwards. The foamed glass is taken from the mould after cooling and is separated in corresponding plates by sawing. The disadvantage of this method is, that moulds have to be used which have to be filled and depleted. Further, the individual blocks of the foam glass have to be separated in corresponding plates. In addition, the known method has the disadvantage that as a starting material newly produced glass, which has to be milled to glass powder, is used.

### DISCLOSURE OF THE INVENTION

### Technical Problem

It is the object of the present invention to provide a method and a device by which in an easy and effective manner plates or in general structural parts can be formed of foam glass in one piece so that no longer single foam glass bodies or particles have to be connected to each other by an additional fixing agent.

### Technical Solution

This object is solved by a method or a device by which a continuously produced string of foam glass, for example comparable to EP 012 114, at the end of a trough-type or continuous furnace is not quenched, but cooled in a controlled way in order to avoid internal stresses which may lead to rupture and break of the foam glass string. Accordingly, a cooling furnace is attached to the continuous furnace, for example an apron conveyer furnace in which the mixture of glass powder and blowing agent is formed to foam glass, whereas the cooling furnace is cooling the glass string over a long distance.

At the end of the cooling furnace the glass string is cut perpendicular to the conveying direction so that single plates are made from the string.

Preferably, the string can additionally be cut along the conveying direction at the lateral sides or at the upper and lower side as well as at one or several places distributed over the width of the glass string, so has to receive several plates having defined boundary surfaces. For example, a corresponding string having a width in the range of 0.5 m to 4.0 m, in particular 1 m to 2 m, preferably in the range of 1.4 m to 1.6 m can be separated in the centre and after 1 m conveying distance so that plates having a width of 0.5 m to 0.75 m and a length of 1 m are produced. The thickness of the plates can be in the range of 10 mm to 150 mm, preferably of 40 mm to 120 mm, in particular 50 mm to 100 mm so that also a corresponding continuous separation with respect to the thickness of the plate can be carried out. However, other dimensions, in particular with respect to a greater width, are possible.

As cutting means diamond saws are particularly considered, for example for the cuts along the conveying direction in form of a circular or a disc saw, which can be disposed at the exist of the cooling furnace.

For the separation of the foam glass string in cross direction a computer-controlled saw can be provided for, which moves during the cutting with the conveying velocity of the foam glass in conveying direction and additionally transverse over the foam glass string for cutting of the same. In this way, different lengths for the plates to be separated can be adjusted. For example, different lengths in the range of 0.5 m to 2.0 m, in particular 1 m, can be achieved.

The advantage of the inventive method can be seen in the continuous carrying out of the cooling and the cutting processes, so that the elaborate filling of the moulds and removing of individual blocks from the mould can be avoided. Moreover, everything is carried out in a continuous process, so that the effectiveness is strongly enhanced.

The cooling furnace for carrying out the method, preferably as corresponding heating and/or cooling means, which allow a defined temperature setting in particular transverse in the direction of the width of the string but also along the conveying direction and accordingly along the cooling roadway.

In particular it is advantageous that at the foam glass string merely a temperature gradient in length or conveying direction is set while the temperature over the width and the thickness of the foam glass string substantially is constant. Thus, the advantage is achieved that stresses in cross direction do not occur and a corresponding stress adjustment or equalization by slow cooling-off has only to be assured in conveying direction.

Preferably, the cooling in conveying direction occurs such that the foam glass moving along the conveying direction is firstly cooled from the foam temperature to an upper relaxation temperature at a first cooling rate, and afterwards at a second cooling rate from the upper relaxation temperature to a lower relaxation temperature and subsequent from the lower relaxation temperature at a third cooling rate to approximately room temperature. The conveying velocity of the foam glass during this is constant and merely the corresponding temperature gradient in the allocated cooling zone of the cooling furnace or the cooling roadway is accordingly set.

The three cooling areas assure that an uniform heat transmission to the cooling medium is ensured, which due to the high fraction of pores is necessary for foam glass.

Preferably, the lowest cooling rate is chosen for the second area, i.e. the cooling from the upper relaxation temperature to the lower relaxation temperature, so that the lowest cooling rate is present there. This is therefore advantageous, since in particular in the temperature region between the upper relaxation temperature and the lower relaxation temperature consistent internal or residual stresses are built up, so that especially good temperature equalization within the glass and accordingly a slow cooling-off of the foam glass is necessary.

The temperatures for the upper relaxation temperature and the lower relaxation temperature are defined by the viscosity of the employed glass or foam glass, respectively. Normally, the foam temperature is in the range of viscosity of 10⁷ to 10⁸ dPa s, in particular 10^{7.6} dPa s, so that the upper relaxation temperature is selected at a viscosity in the range of 10^{12.5} to 10^{13.5} dPa s, in particular 10¹³ dPa s, while the second relaxation temperature is in the range of 10¹⁴ to 10¹⁵ dPa s, in particular 10^{14.5} dPa s.

With respect to the cooling rates it has to be taken into account that the cooling rates and in particular the second cooling rate is set as low that the temperature equalization between air enclosed in the pores and the surrounding glass is ensured, so that no internal stresses are induced into the porous foam glass structure due to the temperature differences. Since air normally is a very good isolator, correspondingly low cooling rates have to be applied. However, these can be accepted, since the lowest cooling rates are advantageously restricted to the range between the upper relaxation temperature and the lower relaxation temperature, so that for the industrial application acceptable cooling times can be achieved.

The cooling is preferably effected by a cooling medium (fluid), which is passed over the foam glass string. The cooling medium, in particular air or other media like inert substances, which, in particular in the hot areas, have to be heated up to the temperatures in the range of the foam glass to be cooled, are passed over the surface of the foam glass string and/or the corresponding conveying elements in a highly turbulent stream according to the invention. Thus, the temperature equalization or heat transmission between the cooling medium and the foam glass can occur. Due to the highly turbulent stream it is assured that a good heat transmission can be achieved by a comparatively small amount of volume flow, since almost everything of the cooling medium passed over the surface of the foam glass to be cooled comes in contact with the surface of the foam glass.

Preferably, the cooling medium is passed over the foam glass string in length direction, whereas the convection in length direction can be carried out parallel, anti-parallel as well as diagonally or with an acute angle to the transport direction. The highly turbulent stream is preferably maintained over the complete cross section in the width and length direction. This is achieved by a separation of the cooling roadway in different segments having respective individual cooling devices.

The separation of the cooling roadway in segments leads further to the advantage that the segments can be designed in a similar way with respect to the basic structure so that the design is simplified. Moreover, in the individual segments conveying means being independently adjusted can be provided for, which also simplifies the design. Due to the separate installation of heating and cooling devices in respective individual segments, the heating and cooling devices can be controlled and adjusted separately and independently from each other.

Preferably, the heating and cooling means are designed such that they comprise transport lines for the cooling medium (fluid) in which the cooling medium is guided within the cooling roadway to distribution devices which dispense the cooling medium to the cooling furnace.

According to a preferable embodiment, the distribution devices are made in the form of a manifold having corresponding dispensing openings or nozzles, respectively. The nozzles are particularly adjustable with respect to their dispensing opening and are particularly independently from each other closable.

Preferably, the openings in the distribution devices or the manifold, respectively, are disposed transverse with their dispensing opening to the streaming-in direction of the cooling medium, so that during streaming out a turbulence of the cooling medium is achieved.

Preferably, the highly turbulent stream can be also maintained by providing corresponding turbulence or deflector elements in the cooling roadway which effect a deflection of the cooling stream and turbulence of the same.

At the entrance positions of the cooling medium into the distribution devices, heating means like gas or oil burners, electric heating, radiation heating or the like, can be provided for, so that an indirect heating of the cooling roadway occurs. However, it is also conceivable to provide for corresponding heating elements directly in the cooling roadway.

In addition to the distribution devices, by which the cooling medium is introduced into the cooling furnace, suction devices are preferably provided for which remove the cooling medium stream from the cooling furnace, particularly for each segment. Accordingly, the distribution devices as well as the suction devices are aligned along the foam glass conveying path in opposing manner and with their openings facing each other. Since the openings of the distribution devices as well as the suction devises are adjustable with respect to the cross section of their opening or with respect to the flow rate and are additionally be designed so that they can be closed, a parallel as well as an anti-parallel length stream of the cooling medium as well as a diagonal stream of the cooling medium can be set by these devices. In addition, the volumina of the cooling medium flowing along the foam glass conveying device can be varied over the width of the foam glass string so that, for example, at the rim of the foam glass string, where cooling occurs earlier, a minor cooling medium stream can be adjusted.

Preferably, the cooling medium taken away from individual segments or sections or zones of the cooling roadway can be directly or after a corresponding temperature adjustment put in in other areas, so that a cooling medium, which was heated up in a cooler section, can be reused in an energy saving-manner.

For energy reasons, it is also advantageous to use transport or conveying devices as well as cooling medium lines or devices having a low heat capacity, since in this way energy for heating up of these components can be saved. Preferably, the mesh size of the foam glass conveying device, which is preferably designed in the form of an endless metal mesh conveyer, is chosen such that the heat capacity is minimized while at the same time a sufficient stabilisation of the foam glass string is ensured. In particular, the mesh size of the metal mesh string can vary over the length of the cooling device, since in colder regions sufficient solidification of the foam glass string has already occurred.

The heating and/or cooling means can be of different kind, namely gas burner, electrical heating, condensing coils, blowers or the like. Preferably, corresponding measuring and sensor devices, allowing an accurate temperature control, are provided in both, the heating furnace as well as the cooling furnace. Further, a corresponding control device is preferably provided which controls or adjusts the heating and/or cooling means depending on the measured temperatures in order to set an exactly defined cooling or heating profile.

Preferably, the heating and/or cooling means are disposed in the cooling furnace above and below the conveying strip as well as lateral thereof in order to avoid undesired temperature differences over the cross section of the foam glass string, which could lead to undesired stresses and destruction of the foam glass string. The conveying device as well as the conveying string has to be manufactured of a temperature resistant material similar to that in the foaming furnace.

The heat capacity of the material forming the conveying device should be smaller than that of the foam glass string, due to its layer thickness. Preferably, the conveying strip or conveying device is made of heat resistant materials.

Preferably, substantially 100% unencumbered recovered glass, which is milled before mixing with the blowing agent and feeding to the foam furnace, is used as glass powder for the inventive method.

The foam glass plates, which are produced according to the above-mentioned method, consist of glass particles which are connected to each other during the foaming process by forming a plurality of particularly uniform pores by means of a kind of sinter process. A part of the substances contained in the blowing agent, no additional fixing agents are necessary. In particular, no foam glass granules are connected to a structural part by using a fixing process by means of an organic or inorganic fixing agent in addition to the foam process, as known in prior art. Accordingly, the present invention is characterized by the fact that one-piece plates or in general structural parts are produced in a continuous process directly following the foaming of the glass, that is actual the production of the foam glass.

### SHORT DESCRIPTION OF THE DRAWINGS

Further advantages, features and characteristics of the present invention will be rendered clear during the following detailed description of embodiments on the bases of the attached drawings. The drawings show in purely schematic way in

FIG. 1 a lateral cross section of an embodiment of a device for continuously producing of one-piece foam glass plates;

FIG. 2 a perspective view of a segment of the cooling furnace or the cooling run of FIG. 1;

FIG. 3 a perspective view of the segment of FIG. 2 in open illustration;

FIG. 4 a cross section of the segment of the FIGS. 2 and 3; and in

FIG. 5 a longitudinal section through the segment of the FIGS. 2 to 4.

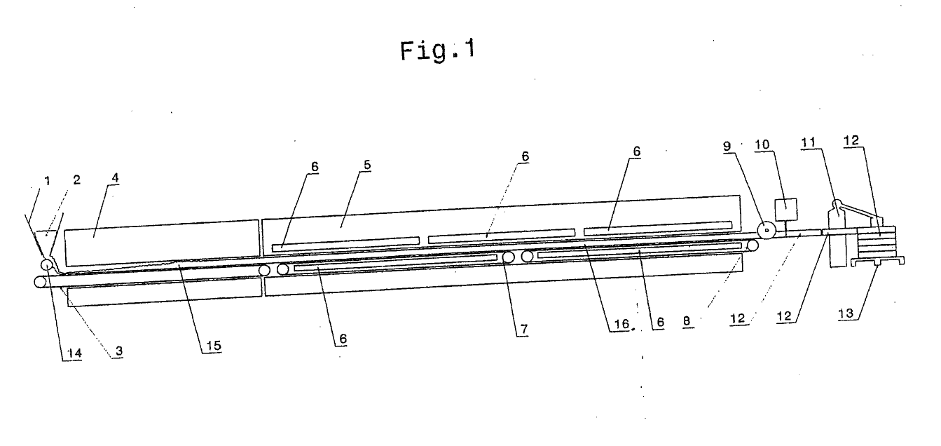

In FIG. 1 a hopper-like feeding device 1 is illustrated in the left half of the image by which the mixture 2 of blowing agent and glass powder can be fed to the feeding roll 14 of an endless conveying device 3 in an uniform manner. By doing this, a piling up 15 on the endless conveying strip 3 is produced, which is transported by the endless conveying strip 3 to the foaming furnace 4 at a defined velocity.

In the foaming furnace 4 not illustrated heating devices are provided for which heat the mixture 2 or the piling up 15, respectively, to the corresponding temperature of about 600° C. to 950° C., particularly about 800° C. to 850° C. Thereby, the foaming process starts and the continuous foam glass string 16 develops, which is transferred in a continuous way to the cooling furnace 5 directly after the production of the foam glass string.

In the cooling furnace 5 corresponding conveying devices 7 and 8 are provided for, on which the foam glass string 16 continuous to be conveyed. Of course, several cooling furnaces or segments having several conveying devices disposed one behind the other or a single cooling furnace with one or several segments having a single conveying device can be provided for.

In the cooling furnace 5 heating devices and/or cooling apparatuses 6 are again provided for which can be provided for both, above and below the foam glass string 16. In addition, lateral to the foam glass string (not shown) heating and/or cooling devices can be provided for, wherein all applicable heating devices and/or cooling apparatuses, like gas burners, electrical heating, blowers or the like, can be provided for.

Due to the uniform and slow as well as defined cooling-off of the foam glass string 16 in the cooling furnace 5 internal stresses caused by the cooling are avoided and continuous, long foam glass plates are produced which have a width according to the conveying device 3 or the conveying devices 7 and 8 which may be in the range between 1 and 2 m, preferably 1.4 m to 1.6 m. However, a greater width up to 4 m is conceivable.

At the end of the cooling furnace 5, when the foam glass string 16 is cooled down to almost room temperature, cutting devices 9 and 10 are provided for in order to separate the foam glass string 16 in individual plates 12. For this purpose cutting devices 9 can be provided for which cut the foam glass string in length direction as well as a cutting device 10 which cuts the plates in cross direction. The cutting devices 9, 10 are preferably formed by diamond cutting tools or band saws. Behind the cutting device an automatic lifting apparatus 11 can be provided for at the end of the device which stacks the cut plates 12 onto a transport unit 17, like a pallet.

The transport conveying devices 3, 7 and 8 have to be constructed of a heat resistant material which can survive the temperatures, which occur during the foaming process in the range of 600° C. to 950° C., in particular in the range of about 800° C. without any damage. Further, the heat capacity of the transport conveying device should be adjusted such that per unit of area the heat capacity of the glass string is greater than that of the transport conveying device. Thus, a corresponding temperature control is ensured. Preferably, cooling means like cooling coils can be provided in the transport conveying devices. The foam glass string normally has at the end a thickness of about 50 mm to 150 mm, preferably 80 mm to 120 mm, wherein the piling up 50 is applied with a layer thickness of 0.5 cm to 5 cm. The foam glass string can be cut with respect to the thickness at the end of the device (not shown).

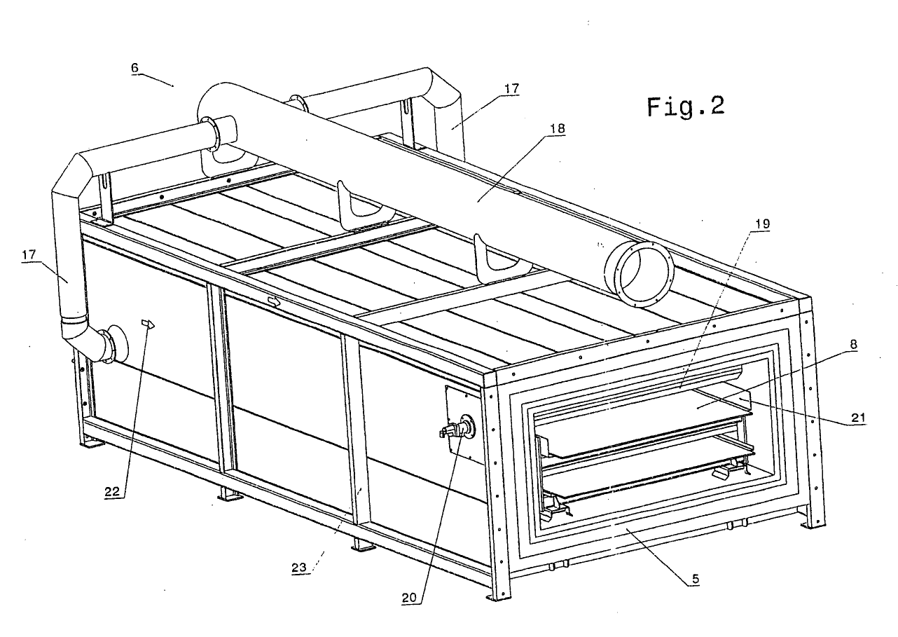

In FIG. 2 a detailed illustration of a segment of the cooling roadway 5 from FIG. 1 is shown. The segment has a cuboid-like basic structure being formed as a housing by corresponding posts and bars 23 with corresponding covering. In the internal space of the cooling device 5 or the corresponding segment, respectively, an endless conveying device 8 in form of a metal mesh string is shown, which comprises lateral guide elements 21, in order to receive the foam glass string (not shown) and transport the same through the cooling device 5. Due to the endless form of the transport conveying device, according to which the metal mesh string is moved in circles, both, the upper part as well as the lower part of the conveying device, are visible in the housing of the cooling device.

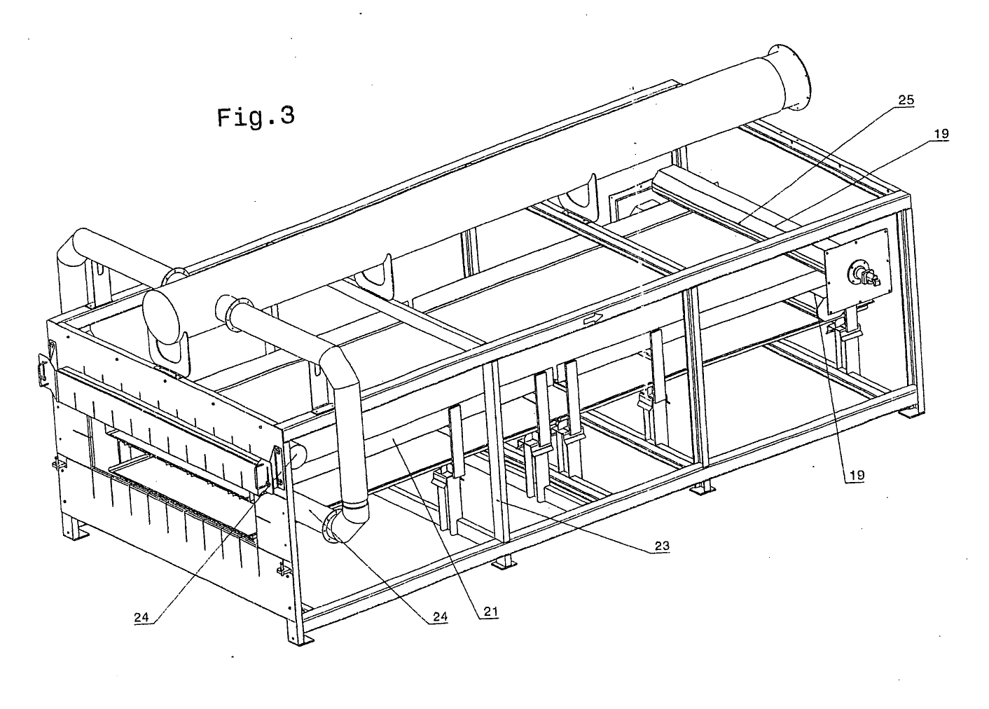

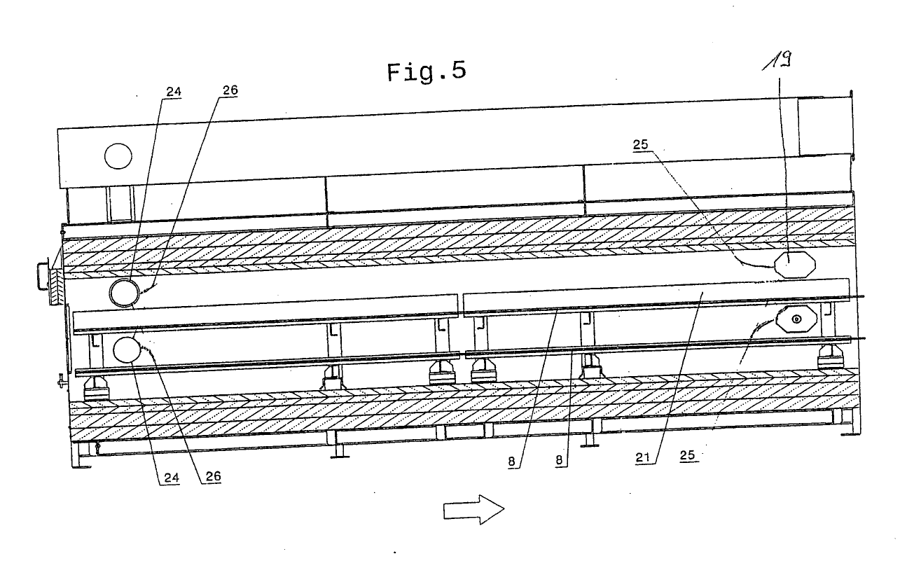

In order to achieve a cooling according to the invention in the cooling run 5, as shown in the embodiment, air or fluid distributors 19 are provided for at the end or exit of the segment with respect to the transport direction shown by the arrows 22 in which corresponding tempered air (fluid) is blown in, in order to come in contact with the foam glass string which is to be cooled. At the inlet side of the segment, with respect to the transport direction, corresponding suction devices 24 are provided for, as can be seen particularly from the FIGS. 3 and 5, the suction devices being connected to fluid lines 17, 18 in order to drain off the blown in heating or cooling medium. Depending on where the segment is arranged in the cooling run, the fluid or medium or particular the mostly used air are heated up to a corresponding temperature or at the end of the cooling device are cooled down, in order to be blown into the cooling furnace or the cooling device 5.

Accordingly, at the inlet 20 of the fluid distributors 19 corresponding cooling or heating elements like gas burners, oil burners, electrical heating or the like can be provided for in order to bring the fluid (medium) to the corresponding temperature. Of course, at the inlet 20 fluid lines can be provided for which, however, are not shown in the figures to simplify matters.

In particular, it is advantageous when the fluid that is removed from the cooling furnace 5 by the suction devices 24 at another appropriate location is given again into the cooling furnace. For example, the cold ambient air blown in at the end of the cooling device can be used for further cooling in the warmer regions, since this air is already heated up by the heat transmission from foam glass to the air.

Of course, for the transport of the fluid (air) corresponding pumps or blowers are provided for which, however, are not illustrated in the drawings.

At the embodiment shown, the fluid distributors 19 and suction devices 24 are disposed above and below the foam glass string along the transport direction in an opposing manner, as can particularly be seen in FIGS. 3 and 5, so that convection of the fluid in length direction, i.e. a fluid stream opposite parallel to the foam glass transport direction, is employed. By this length convection the temperature uniformity in the foam glass string, necessary for cooling of the foam glass, can be assured in a simple manner over the width and the thickness of the foam glass while along the length direction a temperature gradient is present.

As also can be clearly seen from FIGS. 3 and 5, the fluid distributors 19 and the suction devices 24 are designed differently with circular and octagonal cross sections. However, they can be formed identically, so that the stream direction can be adjusted reverse to the foam glass transport direction as well as along the foam glass transport direction by simply changing the function of fluid distributor and suction device by switching over the blower or pump devices.

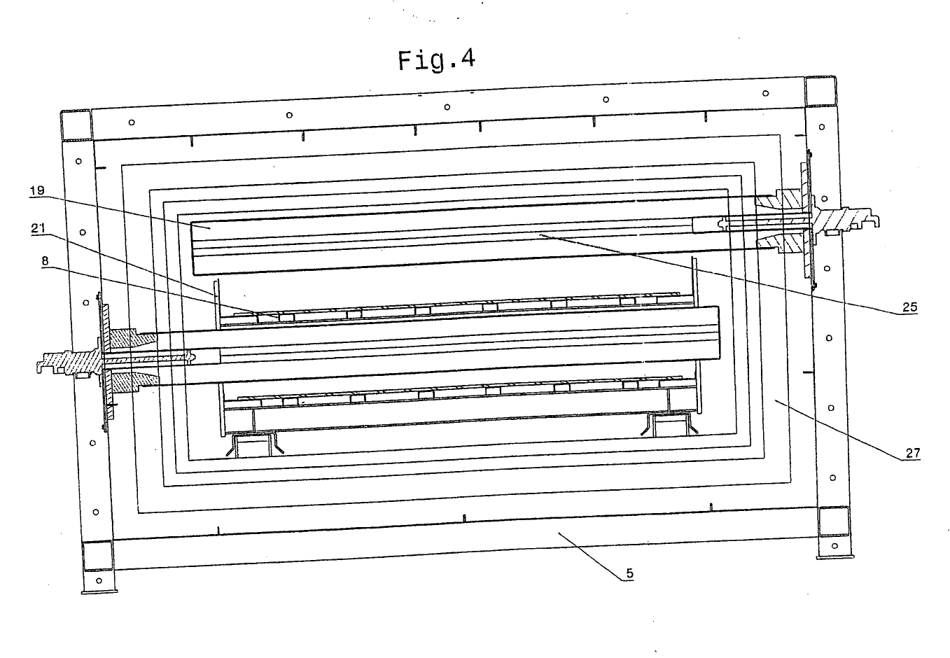

As rendered clearly by the FIGS. 4 and 5, the suction devices and fluid distributors 19 are formed as manifolds disposed across to the foam glass string with a user-defined cross section form. Manifolds have at one side or at opposite sides or circumferentially openings 26 or nozzles 25 in order to dispense the fluid blown into or pumped into the manifold or to suck in fluid into the manifold or dispense from there.

By blowing or pumping in the fluid transverse to the foam glass transport direction and dispensing the fluid in or opposite to the foam glass transport direction a turbulence is achieved during dispensing the fluid through the nozzles 25, which leads to a highly turbulent stream of the fluid to the suction devices 24. Due to this highly turbulent stream an especially good heat transfer from the foam glass to the fluid is achieved, since, due to the turbulence, always sufficient fluid having a capacity for absorbing heat, comes into contact with the foam glass.

Accordingly, it is advantageous to provide for so-called turbulence elements in the area between the fluid distributors and the suction devices, which avoid that a laminar stream is formed. Such turbulence elements are, however, not shown in the figures.

Preferably, the transport conveying device contributes to the turbulence of the fluid, in particular when formed as a metal mesh string, since the metal mesh forms a rough surface which leads the fluid during passing along the surface to turbulences.

From FIGS. 4 to 5 it is clear that fluid distributors 19, as shown in FIG. 4, as well as suction devices 24 are disposed above and below the foam glass string, wherein in particular the fluid distributor 19 or the suction device 24, respectively, are provided for between the carrying run and the back run of the transport conveying device.

The nozzles 25 or openings 26, respectively, of the manifolds of the fluid distributors 19 or suction devices 24, respectively, are designed such that the opening cross section is adjustable, namely independent for each single nozzle along the length direction of the manifold. By this way it is possible to adjust different streaming conditions or diagonal streaming conditions over the cross section, when, for example, the nozzles 25 or openings 26, respectively, of opposing fluid distributors 19 and suction devices 24 are correspondingly closed or opened. A stream distribution being different over the cross section of the foam glass string can particularly be useful such that the stream in the centre is especially strong with an especially high volume stream of the fluid while at the rims, which are cooling faster, as matter of fact, a minor fluid stream is set.

1-28. (canceled)

29. A method of producing one-piece foam glass plates, the method comprising:
forming a foam glass string from glass particles and a blowing agent using a thermal treatment; and
continuously cooling the foam glass string to room temperature at a cooling rate to produce a foam glass structure comprising glass and a plurality of pores, the foam glass structure being essentially free of stresses.

30. The method according to claim 1, further comprising:
after cooling, cutting the foam glass string into a plurality of foam glass plates.

31. The method according to claim 1, wherein cooling the foam glass string includes:
setting a temperature gradient in a direction of transport of the string; and
maintaining a constant temperature over a width and thickness of the foam glass string.

32. The method according to claim 3, wherein cooling the foam glass further comprises:
cooling the foam glass string at a first cooling rate along the direction of transport from a foaming temperature at which the temperature treatment is performed to an upper relaxation temperature;
cooling the foam glass string along the direction of transport at a second cooling rate from the upper relaxation temperature to a lower relaxation temperature; and
cooling the foam glass string along the direction of transport at a third cooling rate from the lower relaxation temperature to room temperature.

33. The method according to claim 4, wherein cooling the foam glass further comprises:
selecting the foaming temperature such that the glass has a first viscosity in a range of 10⁷ dPa to 10⁸ dPa at the foaming temperature;
selecting the upper relaxation temperature such that the glass has a second viscosity in a range of 10^{12.5} dPa to 10^{13.5} dPa at the upper relaxation temperature; and
selecting the lower relaxation temperature such that the glass has a third viscosity in a range of 10¹⁴ dPa to 10¹⁵ dPa at the lower relaxation temperature.

34. The method according to claim 4, wherein the second cooling rate is less than both the first cooling rate and the third cooling rate.

35. The method according to claim 4, further comprising selecting the second cooling rate to achieve temperature equalization between air enclosed in the plurality of pores and the surrounding glass.

36. The method according to claim 4, further comprising:
during cooling, exposing the foam glass string to a correspondingly tempered cooling medium which passes at least one of a surface of the foam glass string and a surface of a corresponding conveying device with a highly turbulent stream.

37. The method according to claim 8, wherein the highly turbulent stream is passed over the surface of the foam glass string in a direction that is selected from the group consisting of: parallel to the transport direction, opposite parallel to the direction of transport, in an acute angle to the direction of transport, and diagonal to the direction of transport.

38. A device for producing a one-piece foam glass plate, the device comprising:
a foaming furnace constructed and arranged to receive glass particles and a blowing agent, and to produce a continuous foam glass string from the glass particles and the blowing agent;
a cooling run disposed adjacent to the foaming furnace; and
a conveying device constructed and arranged to transport the foam glass string from the foaming furnace through the cooling run;
wherein the cooling run comprises at least one of a plurality of heating elements and a plurality of cooling elements disposed along the cooling run and constructed and arranged to cool the foam glass string in a predetermined manner.

39. The device according to claim 10, wherein the cooling run comprises a plurality of modular segments, each modular segment being substantially identical to each other modular segment.

40. The device according to claim 10, wherein the cooling run comprises the plurality of heating elements, and wherein the plurality of heating elements comprises at least one heating element selected from the group consisting of: gas burners, oil burners, electrical heaters, and radiation heaters.

41. The device according to claim 10, wherein the cooling run comprises the plurality of cooling elements, and wherein the plurality of cooling elements comprises at least one of untreated stream media, cooled stream media, and preheated stream media.

42. The device according to claim 10, wherein the plurality of heating elements and/or the plurality of cooling elements are disposed in a location that is selected from the group consisting of: above the conveying device, below the conveying device, and to a lateral side of the conveying device.

43. The device according to claim 10, wherein the cooling run comprises the plurality of cooling elements, and wherein at least one of the plurality of cooling elements is continuously adjustable.

44. The device according to claim 10, wherein the cooling run comprises the plurality of heating elements, and wherein at least one of the plurality of heating elements is continuously adjustable.

45. The device according to claim 10, wherein the cooling run comprises at least one fluid line, and a fluid carried within the fluid line, wherein the at least one fluid line opens into at least one fluid distributor that includes at least one nozzle constructed and arranged to direct the fluid in a fluid stream to bring the fluid into contact with the foam glass string to provide temperature equalization.

46. The device according to claim 17, wherein the cooling run comprises an inlet, and wherein at least one of the plurality of heating and/or cooling elements is disposed in the at least one fluid line directly at the inlet of the cooling run.

47. The device according to claim 17, further comprising at least one suction device coupled to the at least one fluid line and constructed and arranged to draw the fluid through the fluid line.

48. The device according to claim 19, wherein the cooling run is divided into a plurality of cooling zones, each cooling zone being constructed to cool the foam glass string at a different predetermined cooling rate; and wherein at least one fluid distributor and at least one suction device is disposed in each zone to provide independent temperature control in each zone.

49. The device according to claim 19, wherein the at least one fluid line comprises a plurality of fluid lines and a corresponding plurality of fluid distributors; and wherein at least one of the plurality of fluid distributors and at least one suction device are adjustable to produce a fluid stream having a higher flow rate at a center of the foam glass string than at rims of the foam glass string.

50. The device according to claim 17, wherein the fluid distributor comprises an adjustable nozzle.

51. The device according to claim 17, wherein the at least one nozzle is constructed and arranged to cause turbulence in the fluid stream during blowing off of the fluid stream from the fluid distributor.

52. The device according to claim 17, further comprising a plurality of deflection and turbulence elements disposed in the cooling run and constructed and arranged to adjust the fluid stream, the plurality of deflection and turbulence elements being disposed in a location that is selected from the group consisting of: laterally along the cooling run, above the conveying device, and below the conveying device.

53. The device according to claim 11, wherein each modular segment comprises an individual transport device, the transport devices together comprising the conveying device; and wherein each transport device is arranged to rotate in a circle.
